(19) United States
(12) Patent Application Publication
(10) Pub. No.: US 2008/0090564 A1
(43) Pub. Date: Apr. 17, 2008

(54) WIRELESS PHONE MODULE AND METHOD

(76) Inventors: Hamid Najafi, Los Altos Hills, CA (US); Michael S. Cummiskey, San Ramon, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/549,653

(22) Filed: Oct. 15, 2006

(51) Int. Cl. H04Q 7/20

(52) U.S. Cl. 455/425

(57) ABSTRACT

A module includes a transceiver, display and I/O interface. The module can be coupled to a case such that the I/O interface can download data from a memory in the case, including a GUI, graphics, etc. Calls can then be blocked based on the relationship of the caller and the downloaded data.

### TECHNICAL FIELD

This invention relates generally to wireless phones, and more particularly, but not exclusively, provides a wireless phone module capable of being inserted into cases for use as a mobile phone, a personal digital assistant, a gaming device, a multimedia player, an office phone, a home phone, etc.

### BACKGROUND

Wireless phones are being used by millions of people around the world. Oftentimes, a wireless phone becomes a sole or main phone of a user, with the user's contacts' info stored therein. As such, replacement of the wireless phone or switching between carriers is inconvenient because the transfer of the contacts' info to a new wireless phone is complicated. Further, the cost of a new wireless phone can be prohibitive.

In addition, as the wireless phone is the sole or main phone of a user, the users' contacts only know the phone number of the wireless phone. As such, a user's contacts may not know the phone number of an office phone or home phone of the user.

Accordingly, a new wireless phone module and method are needed that overcome the above restrictions.

### SUMMARY

A module includes a transceiver, display and I/O interfaces. The module can be coupled to a case such that the I/O interface can download data from a memory in the case, including all information about the case, such as the Display characteristics, Keypad configuration, wall paper and ring tone profiles, etc. Display and Profiles can then be customized to the specific case. The data stored in the case may also identify the case as “home”, “office”, “party” phone. Calls can then be screened so that only calls received from the corresponding directory will be allowed to go through.

In an embodiment, the module comprises an I/O interface, a transceiver, and a display engine. The I/O interface communicates with the case when the module is coupled to the case. The communicating includes downloading data stored in a memory of the case. The data includes a device ID, display data, and graphics data. The transceiver, which is coupled to the interface, wirelessly transmits and receives data via an antenna. The display engine, which is also coupled to the interface, displays a GUI on a display based on the downloaded display data.

In an embodiment of the invention, a method comprises: downloading data stored in a memory of a case into a module when the module is coupled to the case, the data including a device ID, display data, and graphics data; wirelessly transmitting and receiving data via an antenna; and displaying a GUI on a display based on the downloaded display data.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a wireless phone module and case according to an embodiment of the invention;

FIG. 2 is a block diagram illustrating the wireless phone module;

FIG. 3 is a block diagram illustrating persistent memory of the case;

FIG. 4 is a block diagram illustrating persistent memory of the module;

FIG. 5 is a flowchart illustrating a method of integrating the module with the case; and

FIG. 6 is a flowchart illustrating a method of blocking calls based on case type.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

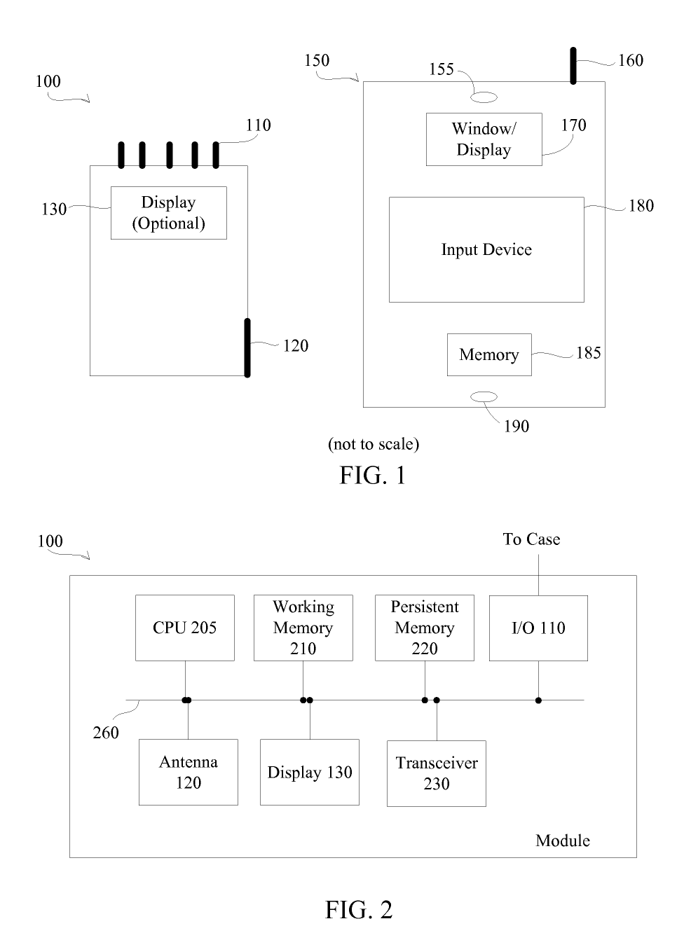

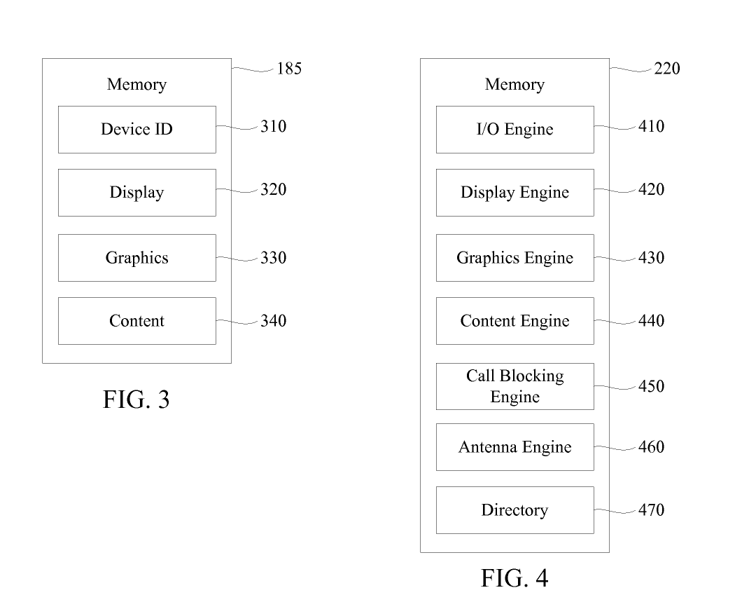

FIG. 1 is a diagram illustrating a wireless phone module 100 and case 150 according to an embodiment of the invention. The module 100, as illustrated, includes an I/O interface 110, an antenna 120, a display 130, which is optional as are other components, and a memory 140. The I/O interface 110, which is illustrated as having 5 pins for purposes of ease of illustration, includes any sort of interface capable of communicating with other devices, e.g., the case 150. The interface 110 can include wired or wireless interfaces, such as a Universal Serial Bus (USB), Bluetooth, Wi-Fi, Ultra Wideband, etc. The interface 110 can be located at any section of the module 100. The antenna 120 connects with a transceiver 230 (FIG. 2) and enables wireless communication with a cell phone tower or other base station. The antenna 120 is internal, but may alternatively be external. The antenna 120 may be located at any external or internal section of the module 100. The display 130 displays graphics, text and other content. In an embodiment, the module 100 also includes an input device, such as a keypad. The components of the module 100 and additional components of the module 100 will be discussed in further detail below in conjunction with FIG. 2 and FIG. 4.

The case 150 includes a speaker 155, an antenna 160, a window 170, an input device 180, such as a keypad and/or other devices, a memory 185, which is located internally or externally to the case 150, and a microphone 190. During operation of the module 100 and case 150, the module 100 is coupled to the case 150 via wired (e.g., via insertion of the shell 100 into the case 150 or coupling to the rear of the case) or wireless techniques such that the module 100 and case 150 can communicate with each other. In an embodiment of the invention, the when the module 100 is inserted into the case 150, the window 170 is approximately the same size as the display 130 and the window 170 overlaps the display 130 such that the display 130 is visible through the window 170. In an embodiment, the case 150 has a display in addition to or instead of the window 170 and the display 130. In an embodiment, the case 150 includes multiple displays (e.g., in a clam shell type case).

The module 100 downloads data from the memory 185, which can include a device ID 310, display data 320, graphics data 330, and content data 340, which will be discussed in further detail in conjunction with FIG. 3. The module uses the data 310-340 to block calls based on the device ID, which will be discussed in further detail in conjunction with FIG. 6, and display data on the display 130 (e.g., case brand name and logo, etc.). The module 100 also receives commands from the input device 180, such as to dial a phone number, and performs the commands. The module 100 can display the entered command on the display 130 as well as results of the command (e.g., number dialed and connected), which will be visible to a user through the window 170. If the case 150 includes an antenna 160, the antenna 160 may be used in place of or in addition to the antenna 120 to wirelessly place calls through a base station. Once a call is placed by the module 100, sound data is sent to the speaker 155, where it is converted to sound for a user to hear. The user can speak into the microphone 190, which converts the sound to data and forwards it to the module 100 for processing and transmission via the antenna 120 and/or antenna 160. In an embodiment of the invention, both antennas 120 and 160 are used jointly to boost signal to noise ratio during receiving and/or transmitting.

In an embodiment of the invention the module 100 and/or the case 150 includes a battery for powering the module 100 and/or the case 150. In an embodiment of the invention, the module 100 and/or the case 150 includes a jack for receiving power from an electrical outlet and/or to power the module 100 and/or the case 150 and/or for charging a battery therein.

As such, the case 150, in combination with the module 100, functions as a mobile phone. As such, users can replace the case 150 with a new case when wanting to replace their mobile phone. In this way, costly electronics in the module 100 are re-used, thereby reducing costs of updating a phone. Further, any data, such as contacts' information, is maintained in the module 100 so that the purchase of a new case 150 does not require the ungainly transfer of data.

In an embodiment of the invention, the case 150 includes a desktop phone for use in an office or home. As such, a user can plug the module 100 into the desktop phone and use the desktop phone to make calls either wirelessly via the module 100 or through a landline of the desktop phone with access to contact data stored in the module 100.

FIG. 2 is a block diagram illustrating the module 100. The module 100 includes a central processing unit (CPU) 205; a working memory 210; a persistent memory 220; the I/O 110, a transceiver 230, an antenna 120, a display 130 (e.g., LCD), and a transceiver 230; all communicatively coupled to each other via a bus 260. The CPU 205 may include an ARM 7 microprocessor, or any other processor capable to execute software stored in the persistent memory 220. The working memory 210 may include random access memory (RAM) or any other type of read/write memory devices or combination of memory devices. The persistent memory 220 may include a hard drive, a FLASH memory, a read only memory (ROM) or any other type of memory device or combination of memory devices that can retain data after the module 100 is shut off. The transceiver 230 converts audio data to and from radio waves, which is received by or transmitted by the antenna 120 or the antenna 160 (through the I/O 110). The transceiver supports multiple communication formats, such as GSM, EDGE, CDMA, UMTS, etc.

FIG. 3 is a block diagram illustrating the memory 185 of the case 150. The memory 185 includes a device ID 310, display data 320, graphics data 330, and content 340. The device ID 310 identifies the type of device (desktop phone, case, etc.) and/or mode of the device (e.g., home, work, mobile, vacation, etc.). In an embodiment, the device ID 310 also indicates if the case 150 includes an antenna. In an embodiment, the device ID 310 also includes wireless carrier information (e.g., which carrier to use and what type of wireless technology, such as CDMA or GSM). The display data 320 includes information on the format for displaying data on the display 130, e.g., a GUI. The graphics data 330 includes graphics for display on the display 130, such as case manufacturer name and/or logo, icons, photos, etc. The content 340 data includes content such as games or other applications (e.g., calculator) to be run by the module 100. During operation of the module 100 when coupled to the case 150, the data from the memory 185 is downloaded to the module 100 and used to display data on the display 130 accordingly.

FIG. 4 is a block diagram illustrating persistent memory 220 of the module 100. The memory 220 includes an I/O engine 410, a display engine 420, a graphics engine 430, a content engine 440, a call blocking engine 450, an antenna engine 460, and a directory 470. The I/O engine 410 communicates with the case 150 including downloading data 310-340 from the memory 185 for use by the engines 420-460. In addition, the I/O engine 410 communicates audio for the speaker 155 and from the microphone 190. The I/O engine 410 further communicates data for the transmitter 160.

The display engine 420 handles the interface on the display 130 (and/or display(s) on the case 150) using the display data 320. The graphics engine 430, using the graphics data 330, provides graphics to the display engine 420 for use in the interface, such as icons and a logo of the case manufacturer. The content engine 440, using the content data 340, runs content in conjunction with the display engine 420. Content include games and applications (e.g., calculator, SMS messaging, etc.). The call blocking engine 450, as will be discussed in further detail in conjunction with FIG. 6, blocks calls based on the mode of phone, which can be indicated by the device ID 310 or overridden by a user. The antenna engine 460, using the device ID 310, determines if the case 150 includes an antenna. If the case 150 does have an antenna, the I/O engine 410 use the case 150 antenna in addition or in place of the antenna 120. The directory stores contact information, such as a contact's name and phone number, and the relationship of the contact to the user. Relationships can include family, work, friends, etc. As such, the call blocking engine 450 can block calls based on the mode and caller ID identifying a caller. As such, when the module 100 is plugged into a home phone or set to home mode, then only calls from family or friends might be let through. Call from work would be blocked. When the module 100 is plugged into a work phone, calls from friends might be blocked while calls from family and work (and unrecognized numbers) might be let through. When in vacation mode, the module 100 will block all calls except from family in one embodiment. When the module 100 is plugged into the case 150 and is therefore in mobile mode (unless overridden) no calls might be blocked.

While the engines 410-460 are illustrated as software, in an embodiment of the invention, the engines 410-460 may be implemented as ASICs or with other technology.

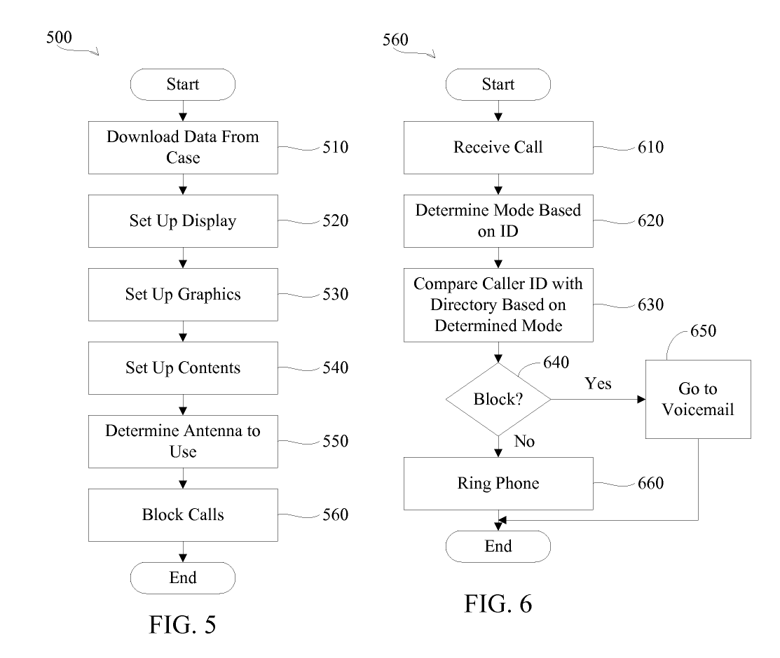

FIG. 5 is a flowchart illustrating a method 500 of integrating the module 100 with the case 150. First, the I/O 110 downloads (510) data 310-340 from the memory 185 of the case 150. The display engine 420 then sets up (520) the display 130 (e.g., a GUI) using the display data 320. The graphics engine 430 then sets up (530) the graphics, such as icons, logos, etc. for use by the display engine 420 using the graphics data 330. The content engine 440 then sets up (540) content, such as applications, etc. using the content 340. The antenna engine 460 then determines (550) which antenna (antenna 120 and/or 160). The determination 550 includes, in one embodiment, sending and/or receiving test signals and comparing their strength. The antenna exhibiting the higher signal-to-noise ratio can be selected. Alternatively, both antennas can be used in combination to strength the signal-to-noise ratio. Calls can then be blocked (560) as will be discussed in further detail below in conjunction with FIG. 6. The method 500 then ends.

FIG. 6 is a flowchart illustrating a method 560 of blocking calls based on case type. First, the module 100 receives (610) a call. The call blocking engine 450 then determines (620) mode based on the device ID 310 (unless overridden). The call blocking engine 450 then compares (630) caller ID of the caller with callers in the directory 470 and their relationship. Based on the comparison (630), the call blocking engine 450 then determines (640) whether to block a call or not. If the call is blocked (640), then it is sent (650) to voicemail, if enabled. Otherwise, the case 150 rings (660) and the method 560 then ends.

The foregoing description of the illustrated embodiments of the present invention is by way of example only, and other variations and modifications of the above-described embodiments and methods are possible in light of the foregoing teaching. For example, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A module capable of coupling to a case, comprising:
an I/O interface capable of communicating with the case when the module is coupled to the case, the communicating including downloading data stored in a memory of the case, the data including a device ID, display data, and graphics data;
a transceiver, coupled to the interface, capable of wirelessly transmitting and receiving data via an antenna; and
a display engine, coupled to the interface, capable of displaying a GUI on a display based on the downloaded display data.

2. The module of claim 1, further comprising:
an antenna coupled to the transceiver; and
an antenna engine capable of determining whether the case includes an antenna based on the device ID and further capable of selecting the module antenna or case antenna for use by the transceiver.

3. The module of claim 2, wherein the antenna engine selects an antenna based on signal-to-noise ratio of each antenna.

4. The module of claim 1, further comprising:
an antenna coupled to the transceiver; and
an antenna capable of determining whether the case includes an antenna based on the device ID and further capable of causing the transceiver to use both antennas to transmit and receive data wirelessly.

5. The module of claim 1, further comprising a call blocking engine capable of blocking calls based on Caller ID of a received call and mode.

6. The module of claim 5, further comprising a directory having phone numbers and relationships, wherein the call blocking engine determines mode based on the device ID, and wherein the call blocking engine determines when to block calls based on the Caller ID, mode, and relationship.

7. The module of claim 1, wherein the transceiver is capable of wirelessly communicating data with a plurality of technologies.

8. The module of claim 7, wherein the transceiver communicates with one of the plurality of technologies based on the device ID.

9. The module of claim 1, wherein the display is a component of the module and wherein the case includes a window that overlaps the display when the module is coupled to the case.

10. The module of claim 1, wherein the display includes one or more displays integrated into the case.

11. A module, comprising:
means for downloading data stored in a memory of a case into a module when the module is coupled to the case, the data including a device ID, display data, and graphics data;
means for wirelessly transmitting and receiving data via an antenna; and
means for displaying a GUI on a display based on the downloaded display data.

12. A method, comprising:
downloading data stored in a memory of a case into a module when the module is coupled to the case, the data including a device ID, display data, and graphics data;
wirelessly transmitting and receiving data via an antenna; and
displaying a GUI on a display based on the downloaded display data.

13. The method of claim 12, further comprising:
determining whether the case includes an antenna based on the device ID and further capable of selecting a module antenna or case antenna for use by a module transceiver.

14. The method of claim 13, wherein the selecting an antenna is based on signal-to-noise ratio of each antenna.

15. The method of claim 12, further comprising:
determining whether the case includes an antenna based on the device ID; and
causing a transceiver to use a module antenna and case antenna to transmit and receive data wirelessly.

16. The method of claim 12, further comprising blocking calls based on Caller ID of a received call and mode.

17. The method of claim 16, further comprising
determining mode based on the device ID, and
determining when to block calls based on the Caller ID, mode, and relationship of the Caller as listed in a directory of the module.

18. The method of claim 12, wherein the wireless transmitting includes selecting one of a plurality of technologies to communicate with.

19. The method of claim 18, wherein the selecting one of the plurality of technologies is based on the device ID.

20. The method of claim 12, further comprising coupling the module to the case and wherein the case includes a window that overlaps a display of the module when the module is coupled to the case.

21. The method of claim 12, further comprising coupling the module to the case and wherein the case includes one or more displays.
